(19) United States
(12) Patent Application Publication
(10) Pub. No.: US 2011/0285282 A1
(43) Pub. Date: Nov. 24, 2011

(54) DEUTERIUM LAMP

(75) Inventor: Torsten Jenek, Frankfurt (DE)

(73) Assignee: Heraeus Noblelight GmbH, Hanau (DE)

(21) Appl. No.: 13/146,767

(22) PCT Filed: Feb. 25, 2010
(86) PCT No.: PCT/EP2010/001157

§ 371 Date: Jul. 28, 2011

(30) Foreign Application Priority Data
Mar. 26, 2009 (DE) 10 2009 014 425.0

(51) Int. Cl. H01J 61/35

(52) U.S. Cl. 313/635

(57) ABSTRACT

A deuterium lamp is provided having a lamp base (1) including electrode feedthroughs (2, 3, 4), having a bulb (10) made of glass and having a housing assembly (11) including an anode (12), cathode (14), and aperture (15), wherein at least one part of the bulb forms a beam discharge surface, and wherein the lamp base and bulb enclose a gas compartment (9). The bulb has a gas diffusion barrier layer (13) on the surface facing the gas compartment at least at the beam discharge surface.

### CROSS-REFERENCE TO RELATED APPLICATIONS

This application is a Section 371 of International Application No. PCT/EP2010/001157, filed Feb. 25, 2010, which was published in the German language on Sep. 30, 2010, under International Publication No. WO 2010/108581 A1 and the disclosure of which is incorporated herein by reference.

### BACKGROUND OF THE INVENTION

The invention relates to a deuterium lamp having a lamp base, which has electrode feedthroughs, having a bulb made of glass and having a housing assembly, which includes the anode, cathode and aperture, wherein at least one part of the bulb forms a beam discharge surface and wherein the lamp base and bulb enclose a gas compartment.

All current deuterium lamps suffer so-called gas wastage. Here, during operation of the lamp, the gas filling diffuses, among other things, into the quartz glass bulb, predominantly at interstitial sites and is thus bound interstitially into the structure. Due to the small atomic radius of deuterium, the diffusion rate for deuterium is significantly higher than for the significantly larger noble gases, for example neon or xenon. This diffusion process is even accelerated by surface activation of the quartz glass through hard UV radiation, which is generated by the deuterium plasma. The diffusion at the quartz glass surface in the region of the beam discharge is therefore particularly high. The diffusion process described here has the result that the fill pressure of the lamp decreases continuously during operation. The arc discharge necessary for operation of the lamp can be maintained only up to a certain minimum pressure. When the pressure falls below this minimum pressure due to gas wastage, the lamp loses intensity drastically and is unusable. The gas wastage thus defines the service life of the lamp.

For deuterium lamps used currently, the inside of the quartz glass bulb is either unprotected or a coating of boron oxide is applied. The boron oxide diffuses into the quartz glass surface and binds itself in a chemical reaction with the layer of the quartz glass close to the surface. The boron oxide coating has the result that the quartz glass surface becomes chemically more resistant. The quartz glass surface thus becomes better protected from reactions with paste material of the cathode, which deposits on the inside of the bulb during operation of the lamp. The paste material of the cathode contains Ba, Sr, and/or Ca. Under the operating conditions of the deuterium lamp, these elements react with the quartz glass surface and thus lead to continuous loss in intensity through optical absorption of the reaction products. The loss in intensity is thus to be traced to chemical reactions. The loss of gas in the lamp is barely affected by the boron oxide coating (See German published patent application DE 37 13 704 A1 and European Patent EP 0 287 706 B1).

From low-pressure mercury or amalgam lamps an aluminum phosphorus oxide coating is known, which protects the quartz glass surface of the emitter from chemical attack by mercury ions. The mercury ions react with the quartz glass to form mercury oxide, which has a greatly absorbent effect and reduces the intensity of the emitter (See German published patent application DE 10 2004 038 556 A1). Thin films are also known from European Patents EP 0 290 669 B1, EP 0 407 548 B1, EP 1 043 755 B1, and European patent application publication EP 1 282 153 A1.

From Xe halogenide excimer lamps an aluminum oxide layer is known, which protects the quartz glass surface of the emitter from chemical attack of the halogenides. The halogenides, which are responsible for the UV emission, react strongly with the quartz glass surface, so that the halogenides are chemically bound in the quartz glass after just a few minutes. Also here, the chemical resistance of aluminum oxide is utilized (See German published patent application DE 10 137 015 A1, similar to Swiss published patent application CH 672 380 A5).

### BRIEF SUMMARY OF THE INVENTION

The invention is based on the object of reducing the gas wastage and improving the service life of deuterium lamps.

The object is achieved by a deuterium lamp of the type described at the outset, wherein the bulb has a gas diffusion barrier layer on its surface facing the gas compartment at least on the beam discharge surface. Thereby, because the bulb has a gas diffusion barrier layer on its surface facing the gas compartment at least on the beam discharge surface, the gas diffusion and thus the gas wastage decrease significantly relative to known technology. Preferably, the gas diffusion barrier layer is formed from aluminum oxide, preferably from amorphous aluminum oxide, because amorphous aluminum oxide is significantly more compact than quartz glass.

It is useful that the gas diffusion barrier layer have a thickness of 10 nm to 10 μm, preferably of 20 nm to 200 nm. The layer thickness can be generated either by a one-time coating or by several coating processes. The gas diffusion barrier layer is preferably optically transparent at a wavelength between 160 nm and 1100 nm.

The gas diffusion barrier layer can be arranged on the entire surface of the bulb facing the gas compartment. The bulb of the deuterium lamp is preferably formed from quartz glass or borosilicate glass, whereby the advantage of the diffusion barrier layer is shown in an especially clear way.

The aluminum oxide can be applied by PVD, CVD, or sol-gel methods. In the sol-gel method the sol-gel can be sprayed, dipped, or applied by drawing a core that acts as a round spatula. Preferably, the layer is deposited in a sol-gel dipping process, in order to achieve a uniform layer quality. Then, the layer is dried for 1 to 24 hours at temperatures between 30° C. and 200° C. Finally, the gas diffusion barrier layer is baked at temperatures between 400° C. and 1400° C., preferably between 600° C. and 1200° C., between 1 and 24 hours, in order to achieve a good barrier effect.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a longitudinal side sectional view of a deuterium lamp having a layer according to the invention;

FIG. 2 is sectional view of a segment from the coated lamp bulb;

FIG. 3 is a graphical representation of the service life profiles (gas pressure over time) of a lamp without a gas diffusion barrier layer (curve A) and a lamp having a gas diffusion barrier layer according to the invention (curve B); and

FIG. 4 is a graphical representation of the intensity profiles over time of a lamp without a gas diffusion barrier layer (curve A) and a lamp having a gas diffusion barrier layer according to the invention (curve B).

### DETAILED DESCRIPTION OF THE INVENTION

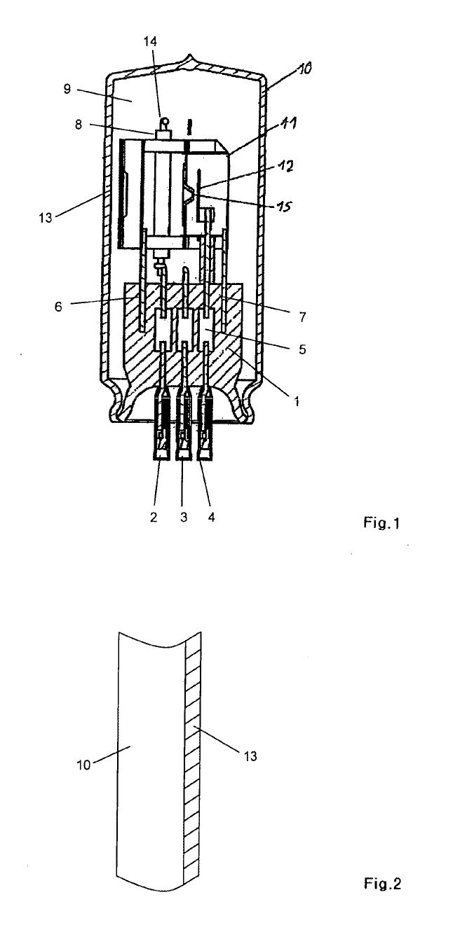

The deuterium lamp shown in FIG. 1 is based on a base 1 made of quartz glass having electrical cathode feedthrough 2, electrical ground feedthrough 3, and electrical anode feedthrough 4. In the electrical feedthroughs 2; 3; 4, molybdenum foils 5 are used to provide for a gas-tight enclosure. The housing assembly 11 of the deuterium lamp is also supported by the front retaining pin 6 and the rear retaining pin 7, in order to increase the mechanical stability. The housing assembly 11 includes the cathode 14, the anode 12, and the aperture 15, which are arranged spaced apart from each other in the housing assembly 11. The cathode 14 is insulated from the housing assembly 11 by the cathode insulation 8. The housing assembly 11 is surrounded by a gas volume 9. The gas is preferably hydrogen or deuterium. The housing assembly 11 and gas volume 9 are enclosed gas-tight by the bulb 10 made of quartz glass and the base 1.

Due to its small atomic radius, deuterium is able to diffuse into the quartz glass structure. Here, the deuterium diffuses predominantly at interstitial sites and is thus bound interstitially in the structure. Chemical bonding with formation of SiD is also possible, but quantitatively negligible. With the significantly larger noble gases (for example neon and xenon), the diffusion rate is significantly lower. This diffusion process is even accelerated by surface activation of the quartz glass by hard UV radiation, which is generated by the deuterium plasma. The diffusion at the quartz glass surface in the region of the beam discharge is therefore particularly high. The diffusion process described here leads to the result that the fill pressure of the lamp decreases continuously during operation. The arc discharge necessary for the operation of the lamp can be maintained only up to a certain minimum pressure. If the pressure falls below this minimum pressure due to gas wastage, then arc discharge is no longer possible and the lamp is unusable. The gas wastage thus defines the service life of the lamp.

Therefore, according to one embodiment of the invention, a gas diffusion barrier layer 13 made of amorphous aluminum oxide is applied on the inside of the bulb 10. Crystalline aluminum oxide is, however, likewise conceivable. The gas diffusion barrier layer 13 is represented in FIG. 2 and is applied on the entire inner surface of the bulb 10.

The gas diffusion barrier layer 13 was applied by a two-fold coating process in the sol-gel dipping process. After each individual coating, it was dried for 12 hours at 100° C. and baked for 12 hours at 900° C. The resulting gas diffusion barrier layer 13 has an overall thickness of 100 nm. It is optically transparent in the range between 160 nm and 1100 nm.

Amorphous aluminum oxide is significantly more compact than the structure of the quartz glass and therefore reduces the deuterium diffusion significantly. The reduction of the gas wastage is represented in FIG. 3. Curve A shows the profile of a lamp without the gas diffusion barrier layer, curve B shows the profile of a lamp having a gas diffusion barrier layer according to an embodiment of the invention. The reduced gas loss allows a significantly longer operating life of the deuterium lamp until reaching the critical fill pressure.

Due to the reduced gas loss, the intensity profile of the deuterium lamp is also improved, because the UV intensity of a deuterium lamp is dependent on the particle density of the fill gas and thus on the fill pressure. The particle density stands in proportion to the number of ionized deuterium molecules, which in turn directly determines the number of generated photons and thus the UV intensity. There is thus an optimum fill pressure at which a maximum of UV intensity is emitted. If the pressure falls below this optimum filler pressure, then the UV intensity drops continuously until extinguishing the arc discharge. The optimum fill pressure of a deuterium lamp lies at approximately 5 mbar, depending on the geometry. The pressure should not fall below a critical pressure of approximately 1 mbar.

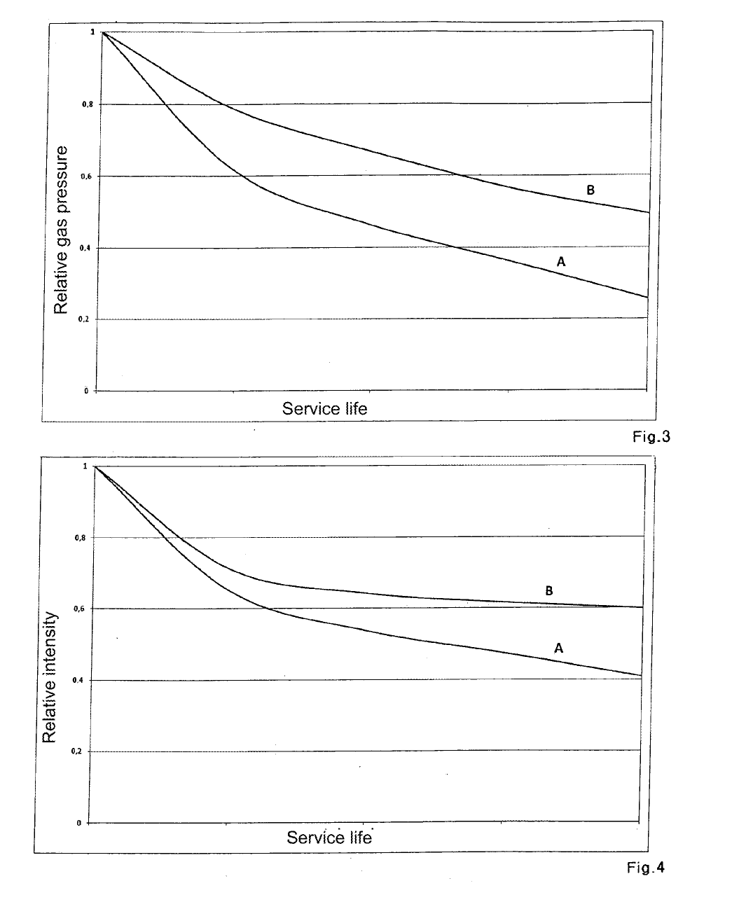

FIG. 4 shows the intensity profiles of a deuterium lamp without gas diffusion barrier layer (curve A) and a deuterium lamp having a gas diffusion barrier layer according to an embodiment of the invention (curve B).

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-6. (canceled)

7. A deuterium lamp comprising a lamp base having electrode feedthroughs, a bulb made of glass, and a housing assembly including an anode, a cathode, and an aperture, at least one part of the bulb forming a beam discharge surface and the lamp base and bulb enclosing a gas compartment, wherein the bulb has a gas diffusion barrier layer on its surface facing the gas compartment at least on the beam discharge surface.

8. The deuterium lamp according to claim 7, wherein the gas diffusion barrier layer comprises aluminum oxide.

9. The deuterium lamp according to claim 8, wherein the aluminum oxide is amorphous aluminum oxide.

10. The deuterium lamp according to claim 7, wherein the gas diffusion barrier layer has a thickness in a range of 10 nm to 10 μm.

11. The deuterium lamp according to claim 10, wherein thickness of the gas diffusion barrier layer is in a range of 20 nm to 200 nm.

12. The deuterium lamp according to claim 7, wherein the gas diffusion barrier layer is arranged on an entire surface of the bulb facing the gas compartment.

13. The deuterium lamp according to claim 7, wherein the gas diffusion barrier layer is transparent for radiation of a wavelength in a range of 160 nm to 1100 nm.

14. The deuterium lamp according to claim 7, wherein the bulb comprises quartz glass or borosilicate glass.
